(19) United States
(12) Patent Application Publication
(10) Pub. No.: US 2026/0199978 A1
(43) Pub. Date: Jul. 16, 2026

(54) ADDITIVE MANUFACTURING APPARATUS

(71) Applicant: Mitsubishi Electric Corporation, Tokyo (JP)

(72) Inventors: Naoya MATSUNAGA, Tokyo (JP); Akiyoshi SAWAI, Tokyo (JP); Yasutaka NAKAMURA, Tokyo (JP)

(73) Assignee: Mitsubishi Electric Corporation, Tokyo (JP)

(21) Appl. No.: 19/137,658

(22) PCT Filed: Jan. 4, 2023
(86) PCT No.: PCT/JP2023/000018

§ 371 Date: Jun. 11, 2025

(51) Int. Cl. B22F 10/22; B22F 10/368; B22F 10/85; B22F 12/20; B22F 12/90; B33Y 10/00; B33Y 50/02

(52) U.S. Cl. CPC B22F 10/22; B22F 10/368; B22F 10/85; B22F 12/20; B22F 12/90; B33Y 10/00; B33Y 50/02

(57) ABSTRACT

An additive manufacturing apparatus includes a material feed unit that feeds a material; a heat source supply unit that supplies a heat source; a temperature measurement unit that measures the temperature of a temperature measurement area that is an area to form an object; a temperature adjustment unit that performs temperature adjustment by heating or cooling the object; and a control unit that derives a temperature gradient in the object, based on temperature distribution information on the temperature measurement area, and derives a solidification rate and a cooling rate in the object, based on the temperature distribution information at different times. Further, the control unit determines manufacturing conditions for forming a layer to be subsequently formed so that the derived temperature gradient, solidification rate, and cooling rate become a temperature gradient, a solidification rate, and a cooling rate for forming a desired structure.

### FIELD

The present disclosure relates to an additive manufacturing apparatus for manufacturing an additively manufactured object by depositing an object formed by melting and solidifying a metal material on a workpiece.

### BACKGROUND

As a technique for manufacturing 3D objects such as parts, an additive manufacturing technique is known. Among additive manufacturing methods, a direct energy deposition (DED) method has advantages that the time required to manufacture an object is shorter, and the amount of material consumed is smaller than that in the other methods.

Patent Literature 1 discloses a technique of deriving the temperature and a temperature gradient of and in a melt pool, based on the intensity of image data on the melt pool captured by an infrared camera, in the above technical field.

### CITATION LIST

### Patent Literature

Patent Literature 1: Japanese Patent No. 6228314

### SUMMARY OF INVENTION

### Problem to be Solved by the Invention

It is known that in additive manufacturing, the internal structure of a manufactured object is not uniform because heat stored in the object varies from the initial stage to the final stage of manufacturing. To uniformly improve the properties of an entire object, it is required to make the entire object achieve a desired structure, to homogenize the entire object. However, the technique described in Patent Literature 1 only derives temperature distribution and the temperature gradient in the melt pool from the intensity of the image data. Furthermore, in Patent Literature 1, it is not considered to homogenize an entire object, and it is unclear how to use the derived temperature distribution and temperature gradient in the melt pool. Therefore, a technique that allows structural homogenization of an entire object has been desired.

The present disclosure has been made in view of the above, and an object thereof is to provide an additive manufacturing apparatus that allows homogenization of the entire structure of an object than ever before.

### Means to Solve the Problem

In order to solve the above-described problem and achieve the object, the present disclosure is an additive manufacturing apparatus that forms an object by staking a layer that is a layer of a molten metal on a substrate serving as a base on which to form the object, and includes a material feed unit, a heat source supply unit, a temperature measurement unit, a temperature adjustment unit, and a control unit. The material feed unit feeds a material in the form of wire or powder to a workpiece that is a layer-forming target, on which area to form a layer. The heat source supply unit supplies a heat source for melting the material to the workpiece. The temperature measurement unit measures the temperature of a temperature measurement area that is an area including the entire area in which to form the object. The temperature adjustment unit performs temperature adjustment by heating or cooling the object. The control unit controls the material feed unit, the heat source supply unit, and the temperature adjustment unit. Here, the control unit derives a temperature gradient in the object, based on temperature distribution information that is the results of measurement of the temperature of the temperature measurement area, and derives a solidification rate and a cooling rate in the object, based on the temperature distribution information at different times. Further, the control unit determines manufacturing conditions for forming a layer to be subsequently formed so that the derived temperature gradient, solidification rate, and cooling rate become a temperature gradient, a solidification rate, and a cooling rate for forming a desired structure. Then, the control unit controls the material feed unit, the heat source supply unit, and the temperature adjustment unit, based on the manufacturing conditions, to perform a manufacturing process.

### Effects of the Invention

The additive manufacturing apparatus according to the present disclosure has an advantage of being able to homogenize the entire structure of an object than ever before.

### BRIEF DESCRIPTION OF DRAWINGS

FIG. 1 is a diagram schematically illustrating an example of a configuration of an additive manufacturing apparatus according to a first embodiment.

FIG. 2 is a diagram for explaining a method of deriving a temperature gradient and a solidification rate from temperature distribution information.

FIG. 3 is a diagram for explaining a method of deriving a temperature gradient in a height direction from the temperature distribution information.

FIG. 4 is a diagram schematically illustrating an example of the relationship between the crystal shape of a solidified metal structure and the combination of a temperature gradient and a solidification rate.

FIG. 5 is a diagram for explaining a method of deriving a cooling rate from the temperature distribution information.

FIG. 6 is a diagram for explaining a method of deriving a cooling rate in the height direction from the temperature distribution information.

FIG. 7 is a diagram for explaining an example of a method of reducing the temperature gradient in the height direction.

FIG. 8 is a block diagram illustrating an example of a hardware configuration of a control device included in the additive manufacturing apparatus according to the first embodiment.

FIG. 9 is a flowchart illustrating an example of a processing procedure of an additive manufacturing method according to the first embodiment.

FIG. 10 is a flowchart illustrating an example of a processing procedure of an additive manufacturing method according to a second embodiment.

FIG. 11 is a flowchart illustrating an example of a processing procedure of an additive manufacturing method according to a third embodiment.

### DESCRIPTION OF EMBODIMENTS

Hereinafter, an additive manufacturing apparatus according to embodiments of the present disclosure will be described in detail with reference to the drawings.

### First Embodiment

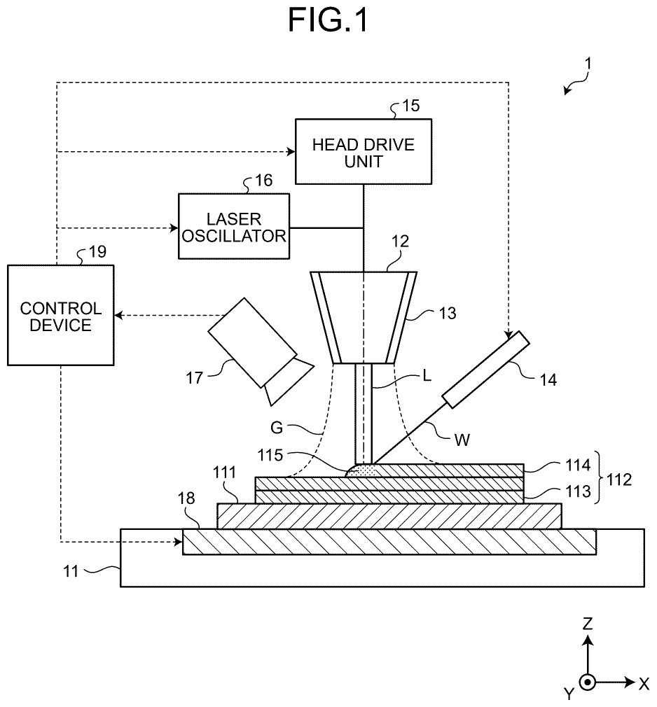

FIG. 1 is a diagram schematically illustrating an example of a configuration of an additive manufacturing apparatus according to a first embodiment. An additive manufacturing apparatus 1 is an apparatus for forming an object 112 by melting a metal material and stacking layers that are layers of the molten metal on a substrate 111. Specifically, the additive manufacturing apparatus 1 melts a wire W that is the metal material together with a portion of a workpiece serving as a base to form a melt pool 115, and forms a layer called a bead made by solidifying the melt pool 115 on the workpiece. Thus, a layer made of the metal material is deposited on the workpiece to form the layer on the surface of the workpiece. By depositing layers into a desired shape, a desired 3D additively manufactured object can be obtained. Hereinafter, the workpiece serves as the base on which for forming a layer, that is, the workpiece is an object on which a layer is formed, and refers to the substrate 111 or a layer. Of the layers, a layer formed on the substrate 111 is referred to as an initial layer 113, and an uppermost layer under formation is referred to as a final layer 114. In one example, when the second layer is under formation, the second layer is the final layer 114. When the third layer is under formation, the third layer is the final layer 114. The object 112 is composed of the layers formed on the substrate 111. That is, the object 112 is composed of the layers from the initial layer 113 to the final layer 114. The object 112 grows during a manufacturing process and finally becomes a 3D additively manufactured object of a desired shape. Furthermore, in the first embodiment, a heat source is a laser beam L and a material is the metal wire W as an example. The heat source is not limited to the laser beam L and may be an arc or an electron beam. The form of the material is not limited to the metal wire W and may be a metal powder. In FIG. 1, a vertical direction is defined as a Z-axis direction, and two directions perpendicular to each other in a plane perpendicular to the Z-axis direction are defined as an X-axis direction and a Y-axis direction.

The additive manufacturing apparatus 1 includes a stage 11, a beam irradiation device 12, a gas ejection device 13, a wire feeder 14, a head drive unit 15, a laser oscillator 16, a temperature measurement device 17, a temperature adjustment device 18, and a control device 19. In FIG. 1, broken lines indicate signal lines.

The substrate 111 serving as a base on which the object 112 is to be formed is placed on the stage 11. In the example illustrated in FIG. 1, the substrate 111 is a plate material but may be a material other than a plate material.

The beam irradiation device 12 is an example of a heat source irradiation unit that irradiates the workpiece with the laser beam L that is the heat source for melting the material. When irradiated with the laser beam L, the workpiece is melted, and the melt pool 115 is generated. After that, the melt pool 115 solidifies in a cooling process, forming a layer.

The gas ejection device 13 ejects a shielding gas G toward a machining point that is the irradiation position of the laser beam L. An example of the shielding gas G is an inert gas such as nitrogen or argon. The ejection of the shielding gas G inhibits oxidation of the workpiece at the machining point, cooling the workpiece. In the example of FIG. 1, the gas ejection device 13 is installed on the outer peripheral surface of the beam irradiation device 12, and ejects the shielding gas G along the central axis of the laser beam L emitted from the beam irradiation device 12. That is, the beam irradiation device 12 and the gas ejection device 13 are coaxially disposed. In the example of FIG. 1, the beam irradiation device 12 and the gas ejection device 13 are integrally formed, constituting a machining head. However, it is only required that the gas ejection device 13 be provided such that the shielding gas G is ejected to an area including the machining point irradiated with the laser beam L to prevent oxidation of the material melting and solidifying at the machining point. Therefore, the gas ejection device 13 may eject the shielding gas G toward the machining point from a direction at an angle from the Z axis. That is, instead of being formed integrally with the beam irradiation device 12, the gas ejection device 13 may be configured to eject the shielding gas G in a direction oblique to the central axis of the laser beam L emitted from the beam irradiation device 12. The gas ejection device 13 is an example of a temperature adjustment unit that performs temperature adjustment by heating or cooling the object 112, and corresponds to a second temperature adjustment unit.

The wire feeder 14 is a device that feeds the wire W to the machining point on the workpiece on which to form a layer. In one example, the wire feeder 14 includes a wire spool around which the wire W is wound, a rotary motor that rotates the wire spool about a rotation axis, and a wire nozzle that advances the wire W from the wire spool to the machining point on the workpiece. The wire feeder 14 is an example of a material feed unit that feeds the material in the form of the wire W or a powder to a workpiece that is a layer-forming target, on which area to form a layer.

The head drive unit 15 moves the beam irradiation device 12 in each of the X-axis direction, the Y-axis direction, and the Z-axis direction. The head drive unit 15 includes a servomotor constituting an operating mechanism for moving the beam irradiation device 12 in the X-axis direction, a servomotor constituting an operating mechanism for moving the beam irradiation device 12 in the Y-axis direction, and a servomotor constituting an operating mechanism for moving the beam irradiation device 12 in the Z-axis direction. The head drive unit 15 is an operating mechanism that allows translational motion in the directions of the three axes. In FIG. 1, the illustration of the servomotors are omitted. The additive manufacturing apparatus 1 can move the irradiation position of the laser beam L on the workpiece by moving the beam irradiation device 12 with the head drive unit 15. The head drive unit 15 is not limited to movement in the perpendicular three-axis directions. A multi-axis drive unit such as a robot arm may be used. In the example of FIG. 1, the head drive unit 15 is a device that drives the machining head since the beam irradiation device 12 and the gas ejection device 13 integrally constitute the machining head.

In the example illustrated in FIG. 1, the beam irradiation device 12 emits the laser beam L in the Z-axis direction. The wire feeder 14 is provided at a position away from the beam irradiation device 12 in the XY plane, and advances the wire W to the machining point from a direction at an angle from the Z axis. Note that the wire nozzle (not illustrated) of the wire feeder 14 may be fixed to the beam irradiation device 12. The wire nozzle may be fixed to the beam irradiation device 12 such that the advance direction of the wire W is the Z-axis direction.

The laser oscillator 16 is a beam source that emits the laser beam L, such as a solid laser, a gas laser, a fiber laser, or a semiconductor laser. The laser oscillator 16 is connected to the beam irradiation device 12 by a fiber cable. The fiber cable is an optical transmission line that propagates the laser beam L from the laser oscillator 16 to the beam irradiation device 12. The laser oscillator 16 and the beam irradiation device 12 constitute an irradiation unit that irradiates the workpiece with the laser beam L that melts the wire W. The laser oscillator 16 is an example of a heat source generation unit that generates the heat source for melting the material. The beam irradiation device 12, the head drive unit 15, and the laser oscillator 16 constitute a heat source supply unit that supplies the heat source for melting the material to the workpiece.

The temperature measurement device 17 measures the temperature of a temperature measurement area that is an area including the entire area in which the object 112 is formed. When the object 112 is formed on the substrate 111, an area including the substrate 111 in addition to the entire area in which the object 112 is to be formed is the temperature measurement area. Here, the temperature measurement device 17 measures temperature distribution in the entire forming area on the substrate 111, that is, the temperature distribution of temperatures at positions in an area including at least the entire substrate 111, and outputs the measured temperature distribution to the control device 19 as temperature distribution information. The temperature measurement device 17 measures temperature distribution in the entire object 112 during the formation of each layer. That is, the temperature measurement device 17 measures temperature distribution in the entire object 112 from the initial layer 113 to the final layer 114 being formed.

As the temperature measurement device 17, a general infrared camera may be used. However, when the temperature of the object 112 is measured using the infrared camera, it is necessary to set emissivity. Emissivity varies depending on the material type and surface state of the object 112. Therefore, when a proper emissivity according to the material type and surface state of the object 112 has not been specified, the control device 19 acquires values different from actual temperature from the temperature measurement device 17 as the temperature of the object 112, and performs control with the temperature different from the actual temperature. In this case, there is a problem that the object 112 having a desired structure cannot be obtained.

Therefore, in the first embodiment, the temperature measurement device 17 is preferably a two-color thermography camera that measures the temperature of a temperature measurement area from the intensity ratio of infrared radiation or visible radiation of two different wavelengths emitted from an object to be measured. The two-color thermography camera is a radiation thermometer that acquires a two-dimensional temperature distribution, and obtains the surface temperature of an object within the field of view by measuring the thermal radiance of the object. Specifically, as described above, the two-color thermography camera calculates the radiance ratio from the intensities, that is, light intensities of each pixel in an image of the temperature measurement area in two wavelength bands, and calculates the temperature at each pixel from the radiance ratio. Then, the representation of the temperatures at pixels becomes the temperature distribution information. Each pixel in the image of the temperature measurement area corresponds to each position in the temperature measurement area. This provides the temperature distribution information in which the temperature at each pixel of the image of the temperature measurement area is obtained. This use of the results of measurement of the temperature measurement area with the two-color thermography camera eliminates the need to set emissivity that is required to measure temperature with a general infrared camera. That is, in such a case where emissivity varies depending on the material type and surface state of the object 112, the temperature of the object 112 can be accurately measured as compared with the case of using an infrared camera without setting emissivity.

The temperature measurement device 17 is disposed, in one example, obliquely adjacent to the beam irradiation device 12, or is disposed at a position where the entire forming area can be captured. When disposed obliquely adjacent to the beam irradiation device 12, that is, at an angle from a vertical line, the temperature measurement device 17 can measure the temperature of not only the top surface but also the side surface of the object 112 with layers stacked in the height direction. That is, the temperature measurement device 17 is disposed so that it can measure the temperature of not only the top surface but also the side surface of the object 112 in the temperature measurement area that is the area including the entire area in which to form the object 112. By acquiring the temperature distribution in the object 112 measured by the temperature measurement device 17, the temperature of the object 112 being formed can be monitored in real time. Furthermore, by using the temperature distribution measured by the temperature measurement device 17, not only the temperature in a layer being formed but also the temperature in a layer(s) previously formed can be acquired. The temperature measurement device 17 corresponds to a temperature measurement unit.

The temperature adjustment device 18 heats or cools the substrate 111 so that the temperature of the substrate 111 is maintained at a temperature set by the control device 19. An example of the temperature adjustment device 18 is a heating device using high-frequency induction heating, a heating device using an electric heating wire such as a hot plate, a cooling device using a water-cooled heat sink, a cooling device using a thermoelectric cooling element such as a Peltier module, or the like. Alternatively, the temperature adjustment device 18 may be a combination of any of the heating devices and any of the cooling devices. In the example of FIG. 1, the temperature adjustment device 18 is provided in the stage 11 so as to heat or cool the substrate 111 from the bottom of the substrate 111. The temperature adjustment device 18 is an example of the temperature adjustment unit that performs temperature adjustment by heating or cooling the object 112, and corresponds to a first temperature adjustment unit.

The control device 19 controls the additive manufacturing apparatus 1, specifically, the beam irradiation device 12, the gas ejection device 13, the wire feeder 14, the head drive unit 15, the laser oscillator 16, and the temperature adjustment device 18, according to a processing program. The control device 19 is a numerical control device in one example. The control device 19 corresponds to a control unit. The control device 19 outputs a movement command to the head drive unit 15 to control the driving of the head drive unit 15. Upon receiving input of the movement command, the head drive unit 15 moves the beam irradiation device 12 according to the movement command.

The control device 19 outputs a command according to a condition for beam output that is the output of the laser beam L to the laser oscillator 16, to control laser oscillation by the laser oscillator 16.

The control device 19 outputs a command according to a condition for the amount of feed of the material to the wire feeder 14, to control the wire feeder 14. The control device 19 controls the driving of the wire feeder 14, more specifically, the driving of the rotary motor, to adjust the feed rate of the wire W toward the beam irradiation position. The feed rate represents the amount of the material fed per unit time.

The control device 19 outputs a command according to a condition for the amount of supply of the shielding gas G to the gas ejection device 13, to control the amount of supply of the shielding gas G ejected from the gas ejection device 13.

Based on the temperature distribution information acquired from the temperature measurement device 17, the control device 19 adjusts manufacturing conditions including the movement command to the head drive unit 15, the condition for the beam output, the condition for the amount of feed of the material, the condition for the amount of supply of the shielding gas G, and a temperature condition for the temperature adjustment device 18, to homogenize the entire structure of the object 112. The control device 19 outputs commands to the gas ejection device 13, the wire feeder 14, the head drive unit 15, the laser oscillator 16, and the temperature adjustment device 18, to meet the adjusted manufacturing conditions. The control device 19 outputs various commands to control the entire additive manufacturing apparatus 1.

Here, description is given of the adjustment of the manufacturing conditions by the control device 19 using the temperature distribution information measured by the temperature measurement device 17. The control device 19 derives a temperature gradient, a solidification rate, and a cooling rate, based on the temperature distribution information on the temperature measurement area acquired from the temperature measurement device 17. Specifically, the control device 19 derives a temperature gradient based on the temperature distribution information on the temperature measurement area at a certain time point, and derives a solidification rate and a cooling rate based on the temperature distribution information on the temperature measurement area at different time points. Here, a temperature gradient, a solidification rate, and a cooling rate in the object 112 are derived. Each temperature gradient has a value obtained by dividing the temperature difference between any two positions by the distance between the two positions. For the temperature gradient, not only a temperature gradient between positions in the horizontal direction but also a temperature gradient between positions in the height direction is derived. In one example, a temperature gradient between positions in the horizontal direction is derived using the top surface of the final layer 114 in the temperature distribution information. In one example, a temperature gradient between positions in the height direction is derived using the side surface of the object 112 in the temperature distribution information. A solidification rate is the rate at which a solid-liquid interface that is the interface between the melt pool 115 and the object 112 moves. A cooling rate is the temperature difference per unit time, that is, the amount of change in temperature per unit time at an arbitrary fixed position in the cooling process.

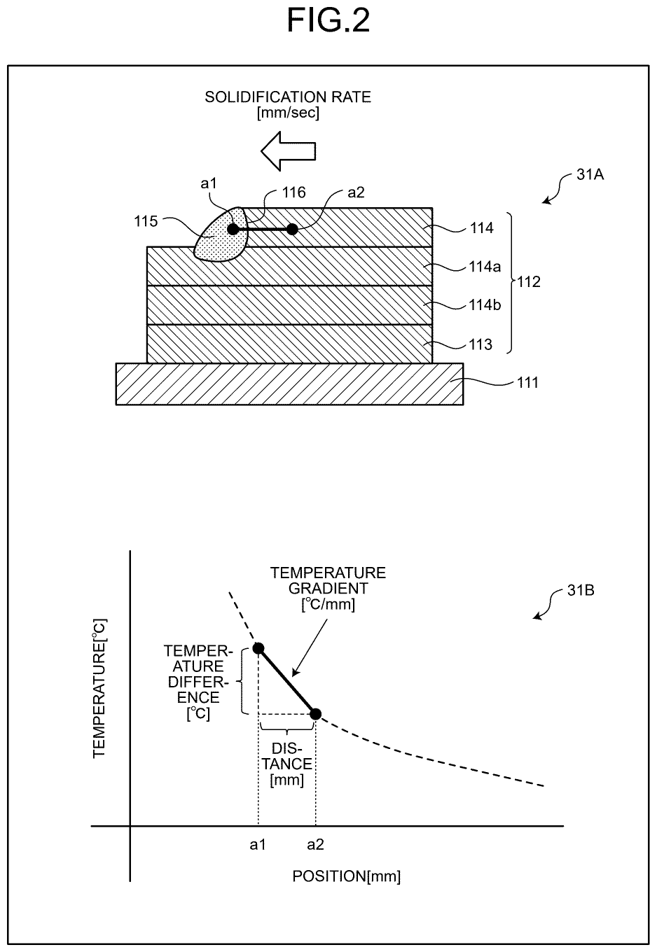

FIG. 2 is a diagram for explaining a method of deriving a temperature gradient and a solidification rate from the temperature distribution information. FIG. 2 illustrates a schematic manufacturing diagram 31A schematically illustrating a state in which the object 112 is being formed on the substrate 111, and a temperature distribution diagram 31B illustrating the distribution of temperatures at positions in the final layer 114 illustrated in the schematic manufacturing diagram 31A.

The schematic manufacturing diagram 31A illustrates a state in which the initial layer 113, a layer 114b formed two layers before the final layer 114, and a layer 114a formed one layer before the final layer 114 are stacked on the substrate 111, and the final layer 114 is being formed on the layer 114a. In the schematic manufacturing diagram 31A, the layers of the initial layer 113 to the final layer 114 constitute the object 112. The laser beam L (not illustrated) is emitted to the position of the melt pool 115 where part of the layer 114a serving as the base and the wire W (not illustrated) are melted. In this example, the laser beam L is emitted from right to left in the drawing. In this example, the final layer 114 is formed by the solidification of the melt pool 115. The interface between the melt pool 115 and the final layer 114 in solid form is a solid-liquid interface 116. The rate at which the solid-liquid interface 116 moves per unit time is the solidification rate.

In the temperature distribution diagram 31B, the horizontal axis represents the position in the temperature measurement area, and in this example, represents the horizontal position in the final layer 114, and the vertical axis represents the temperature. That is, the temperature distribution diagram 31B illustrates temperatures at positions where the final layer 114 is formed. In the schematic manufacturing diagram 31A, the laser beam L is scanned from right to left. That is, the further to the right, the earlier the time point of melt. Thus, the temperature decreases from the position of the melt pool 115 toward the right on the horizontal axis. Although not illustrated, the left side of the melt pool 115 is not heated yet and thus has a low temperature.

The control device 19 derives a temperature gradient from the distance and the temperature difference between arbitrary horizontal positions a1 and a2 in the final layer 114, based on the acquired temperature distribution information. The temperature gradient can be obtained by dividing the calculated temperature difference by the calculated distance. By obtaining in advance the relationship between units of distance in the temperature distribution information and an actual distance on the workpiece in the temperature measurement area, the distance between the arbitrary positions a1 and a2 in the temperature distribution information can be converted into an actual distance on the substrate 111 or on the workpiece.

The control device 19 has acquired the melting point of the wire W in advance. Thus, the control device 19 acquires the position of the solid-liquid interface 116 between the melt pool 115 and the object 112 from the melting point of the wire W and the temperature distribution information. The control device 19 derives a solidification rate that is the moving rate of the solid-liquid interface 116 from the positions of the solid-liquid interface 116 obtained from a plurality of pieces of the temperature distribution information at different time points. In one example, the solidification rate is derived by dividing the amount of change in the position of the solid-liquid interface 116 between two time points by the difference thereof. Thus, the coordinate position of a specific temperature at each time point can be acquired from the temperature distribution information obtained by the temperature measurement device 17. By setting the specific temperature to the melting point of the wire W, position information on the solid-liquid interface 116 at each time point can be acquired, so that the moving rate of the solid-liquid interface 116, that is, the solidification rate can be acquired.

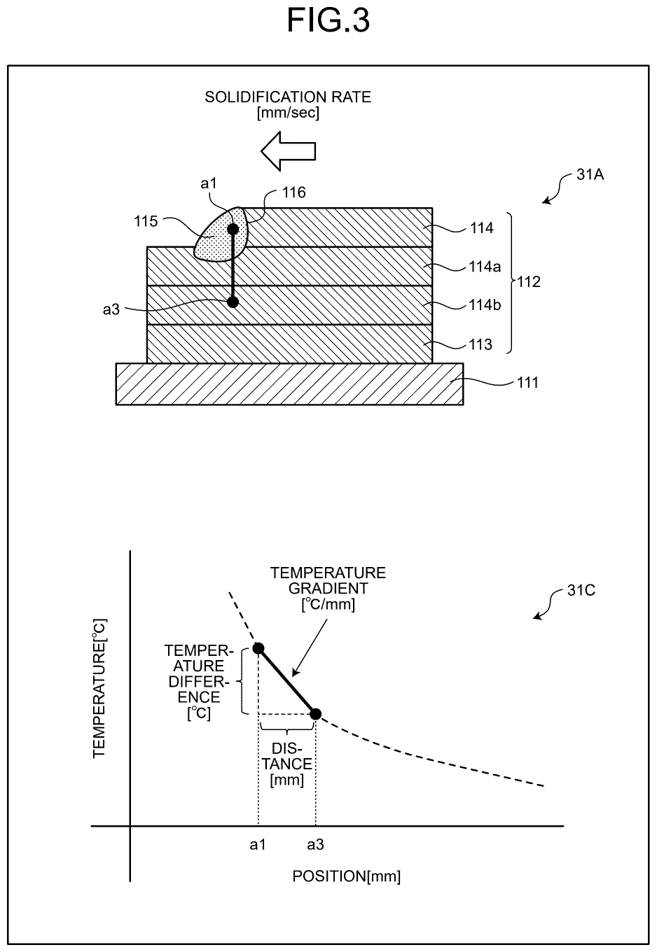

FIG. 3 is a diagram for explaining a method of deriving a temperature gradient in the height direction from the temperature distribution information. FIG. 3 illustrates a schematic manufacturing diagram 31A schematically illustrating a state in which the object 112 is being formed on the substrate 111, and a temperature distribution diagram 31C illustrating temperature distribution in the height direction of the position a1 in the final layer 114 illustrated in the schematic manufacturing diagram 31A. The same components as those in FIG. 2 are denoted by the same reference numerals, and the description thereof will be omitted.

The first embodiment is intended not only to homogenize the structure of the object 112 in the same layer but also to homogenize the structure of a larger area including that in the height direction, that is, the vertical direction from the initial layer 113 to the final layer 114. Therefore, not only a temperature gradient in the in-plane direction but also a temperature gradient in the height direction in the temperature measurement area is acquired.

In the temperature distribution diagram 31C, the horizontal axis represents the position in the height direction of a certain position in the temperature measurement area, and the vertical axis represents the temperature. In the schematic manufacturing diagram 31A, layers are successively formed from the initial layer 113 to the final layer 114. That is, the lower the layer, the earlier the time point of melt. Thus, the temperature decreases downward from the position a1 of the melt pool 115 on the horizontal axis.

The control device 19 derives a temperature gradient from the distance and the temperature difference between arbitrary positions a1 and a3 in the height direction, based on the acquired temperature distribution information. The temperature gradient can be obtained by dividing the calculated temperature difference by the calculated distance.

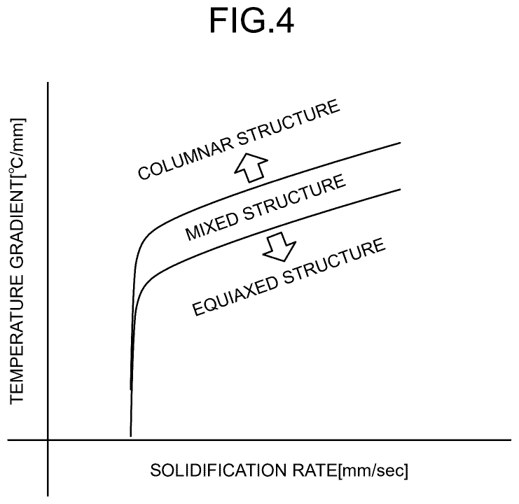

FIG. 4 is a diagram schematically illustrating an example of the relationship between the crystal shape of a solidified metal structure and the combination of a temperature gradient and a solidification rate. In FIG. 4, the horizontal axis represents the solidification rate of the metal, and the vertical axis represents the temperature gradient of the metal. The crystal shape of the metal structure is typically determined from the relationship between the temperature gradient and the solidification rate at the solid-liquid interface 116. When the crystal shape of the structure is a columnar structure, the mechanical properties of this metal have anisotropy. When the crystal shape of the structure is an equiaxed structure, the mechanical properties of the metal have no anisotropy. Therefore, by controlling a temperature gradient and a solidification rate at the solid-liquid interface 116, the crystal shape of the structure of the object 112 can be controlled, and as a result, the mechanical properties of the object 112 can be controlled.

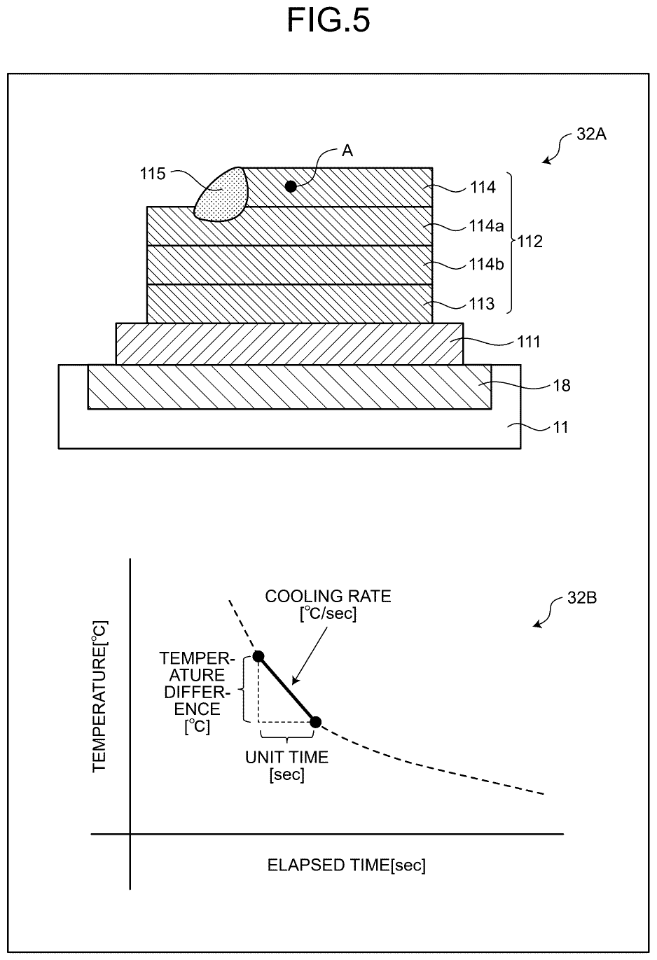

FIG. 5 is a diagram for explaining a method of deriving a cooling rate from the temperature distribution information. FIG. 5 illustrates a schematic manufacturing diagram 32A schematically illustrating a state in which the object 112 is being formed on the substrate 111, and a temperature temporal change diagram 32B illustrating temporal changes in temperature at an arbitrary fixed position A in the final layer 114 illustrated in the schematic manufacturing diagram 32A. The same components as those in the schematic manufacturing diagram 31A of FIG. 2 are denoted by the same reference numerals, and the description thereof will be omitted.

In the schematic manufacturing diagram 32A, the laser beam L (not illustrated) is emitted to the position of the melt pool 115 into which part of the layer 114a serving as the base of the final layer 114 and the wire W are melted. In this example, the laser beam L is emitted from right to left in the drawing. The object 112 is formed by the solidification of the melt pool 115.

In the temperature temporal change diagram 32B, the horizontal axis represents the elapsed time, and the vertical axis represents the temperature. When the wire W is fed to the position A and irradiated with the laser beam L, the base layer 1148 and the wire W at the irradiation position melts, forming the melt pool 115. Since the laser beam L is scanned from right to left in the schematic manufacturing diagram 32A, the temperature at the position A that has been low rises and then decreases. The temperature temporal change diagram 32B illustrates how the temperature decreases at the position A after irradiation with the laser beam L. In one example, the temperature temporal change diagram 32B is generated by extracting the temperature at the position A in the held temperature distribution information at each time point.

The control device 19 derives a cooling rate from the elapsed time and a temperature history at the arbitrary fixed position A. That is, the control device 19 calculates the temperature difference per unit time from the temperature temporal change diagram 32B.

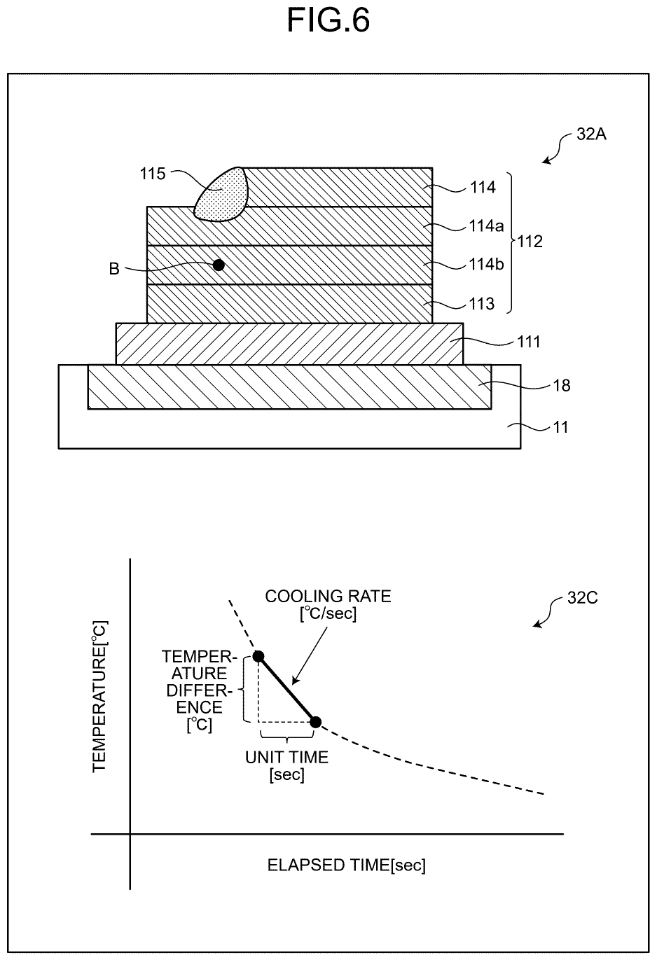

FIG. 6 is a diagram for explaining a method of deriving a cooling rate in the height direction from the temperature distribution information. FIG. 6 illustrates the schematic manufacturing diagram 32A schematically illustrating a state in which the object 112 is being formed on the substrate 111, and a temperature temporal change diagram 32C illustrating temporal changes in temperature at an arbitrary fixed position B in the object 112 illustrated in the schematic manufacturing diagram 32A. In FIG. 6, the position B is in the layer 114b, not in the final layer 114. The same components as those in the schematic manufacturing diagram 31A of FIG. 2 are denoted by the same reference numerals, and the description thereof will be omitted.

In the temperature temporal change diagram 32C, the horizontal axis represents the elapsed time, and the vertical axis represents the temperature. In the schematic manufacturing diagram 32A, the temperature at the position B becomes highest when the layer 114b is formed, and after that, the temperature decreases as the layer 114a and the final layer 114 are successively formed on the layer 114b. The temperature temporal change diagram 32C illustrates how the temperature at the position B decreases during the manufacturing process. In one example, the temperature temporal change diagram 32C is generated by extracting the temperature at the position B in the held temperature distribution information at each time point.

The control device 19 derives a cooling rate from the elapsed time and a temperature history at the arbitrary fixed position B. That is, the control device 19 calculates the temperature difference per unit time from the temperature temporal change diagram 32C.

The cooling rate affects the size of the metal structure and the type of precipitated phase after solidification. In the present description, the size of the structure is the size of crystal grains constituting the structure. In this case, a statistical value such as the mean value of the major diameter can be used as the size of the crystal grains. The type of precipitated phase indicates the type of intermetallic compound generated in the metal cooling process or the type of structure generated with changes in the crystal structure such as martensite.

In one example, when the cooling rate is high, the metal structure becomes finer, and the hardness and the strength at room temperature are increased. Furthermore, when the cooling rate is high in a steel material after being melted, martensite is generated, increasing the hardness. Therefore, by controlling the cooling rate, the structure size and the precipitated phase type of the object 112 can be controlled, and as a result, the mechanical properties of the object 112 can be controlled.

To homogenize the object 112 into a desired structure, the control device 19 determines the manufacturing conditions for manufacturing a layer to be subsequently formed so that the derived temperature gradients, solidification rate, and cooling rate become a predetermined temperature gradient, a predetermined solidification rate, and a predetermined cooling rate. That is, the control device 19 determines, as the subsequent manufacturing conditions, the output of the laser beam L, the scanning speed of the laser beam L, the feed rate of the wire W, the flow rate of the shielding gas G, the temperature of the substrate 111, and a waiting time until the manufacturing process is performed on the next layer, based on the derived temperature gradients, solidification rate, and cooling rate.

The relationships between the temperature gradients, the solidification rate, and the cooling rate, and the manufacturing conditions vary depending on the type of the wire W and the like, and are not uniformly determined. Therefore, the relationships between the temperature gradients, the solidification rate, and the cooling rate, and the manufacturing conditions are not particularly limited and can be obtained by any method in advance. In one example, manufacturing may be actually performed with the wire W of a certain material under various manufacturing conditions to obtain a temperature gradient, a solidification rate, and a cooling rate under each manufacturing condition in advance. Alternatively, by thermal analysis using the finite element method (FEM), a temperature gradient, a solidification rate, and a cooling rate under arbitrary manufacturing conditions may be obtained in advance. That is, temperature gradients, solidification rates, and cooling rates obtained by the actual manufacturing process or thermal analysis when manufacturing conditions including the output of the laser beam L, the scanning speed of the laser beam L, the feed rate of the wire W, the flow rate of the shielding gas G, the temperature of the substrate 111, and the time until the formation of the next layer is performed are variously changed, may be stored as manufacturing condition information. Then, the control device 19 acquires manufacturing conditions under which a desired temperature gradient, solidification rate, and cooling rate are obtained from the manufacturing condition information, and performs the manufacturing process according to the acquired manufacturing conditions. That is, based on the manufacturing conditions, the control device 19 controls the gas ejection device 13, the wire feeder 14, the head drive unit 15, the laser oscillator 16, and the temperature adjustment device 18, to perform the manufacturing process. Consequently, in the subsequent layer manufacturing process, the desired temperature gradient, solidification rate, and cooling rate are obtained.

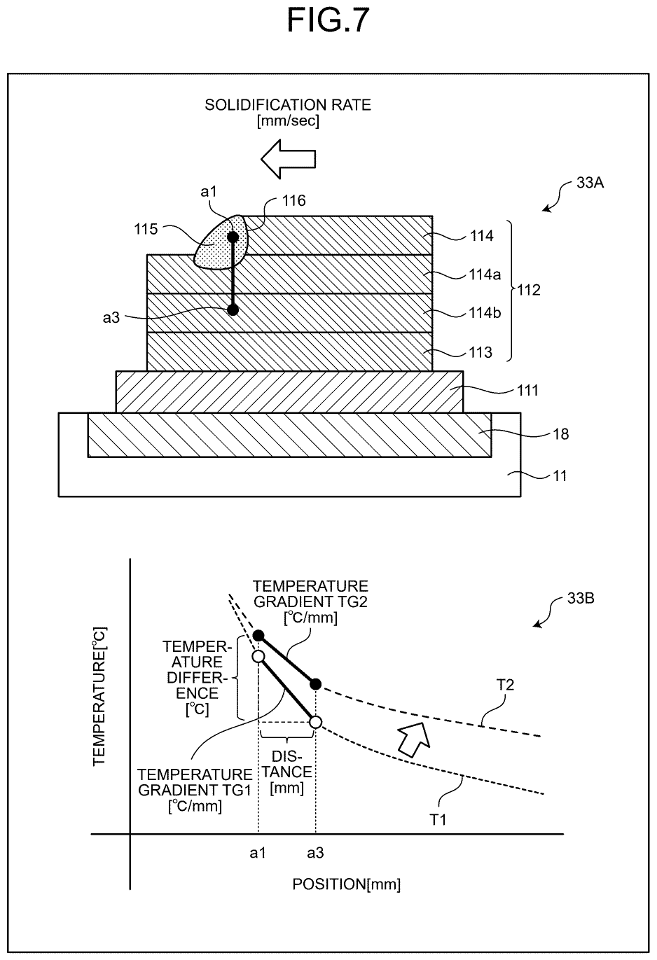

During the manufacturing process, the control device 19 derives temperature gradients and a solidification rate from the temperature distribution information on the object 112, and determines whether the derived temperature gradients and solidification rate are within predetermined thresholds. FIG. 7 is a diagram for explaining an example of a method of reducing the temperature gradient in the height direction. FIG. 7 illustrates a schematic manufacturing diagram 33A schematically illustrating a state in which the object 112 is being formed on the substrate 111 including the temperature adjustment device 18, and a temperature distribution diagram 33B illustrating temperature distribution in the height direction of the position a1 in the final layer 114 illustrated in the schematic manufacturing diagram 33A. The same components as those in FIG. 2 are denoted by the same reference numerals, and the description thereof will be omitted.

In the temperature distribution diagram 33B, the temperature distribution in the height direction at the position a1 is as indicated by a curve T1. The control device 19 derives a temperature gradient TG1 in the height direction at the position a1 from the position a1 and the position a3 different in the height direction. In the case where the control device 19 determines that the derived temperature gradient TG1 is greater than the threshold, the control device 19 reduces the output of the laser beam L or increases the temperature of the substrate 111 by the use of the temperature adjustment device 18 after that. By performing the manufacturing process on the next layer under this condition, the temperature distribution in the height direction at the position a1 changes as indicated by a curve T2 in the temperature distribution diagram 33B. That is, a temperature gradient TG2 in the height direction at the position a1 is smaller than the temperature gradient TG1. In this manner, the control to reduce temperature gradients in layers is performed.

Alternatively, when the control device 19 determines that the derived solidification rate is lower than the threshold, the control device 19 performs control to increase the solidification rate in the layer by increasing the scanning speed of the laser beam L or increasing the flow rate of the shielding gas G after that.

The control device 19 derives a cooling rate from the temperature distribution information on the entire object 112, and determines whether the derived cooling rate is within the predetermined threshold. In one example, when the control device 19 determines that the derived cooling rate is lower than the threshold, the control device 19 performs control to increase the cooling rate in the layer by reducing the output of the laser beam L, increasing the scanning speed of the laser beam L, or increasing the flow rate of the shielding gas G after that. Since the control device 19 derives temperature gradients, a solidification rate, and a cooling rate at each position in the temperature measurement area including the entire substrate 111 or the entire area in which to form the object 112, the manufacturing conditions in the manufacturing process at each position in the next layer are determined based on the temperature gradients, the solidification rate, and the cooling rate described above. The temperature gradients, the solidification rate, and the cooling rate at each position in the object 112 during the formation of the previous layer are affected by heat storage in the object 112. Therefore, the manufacturing conditions for the next layer takes the heat storage into consideration.

Next, a hardware configuration of the control device 19 will be described. The functions of the control device 19 are implemented by executing a control program that is a program for performing the control of the additive manufacturing apparatus 1, using hardware.

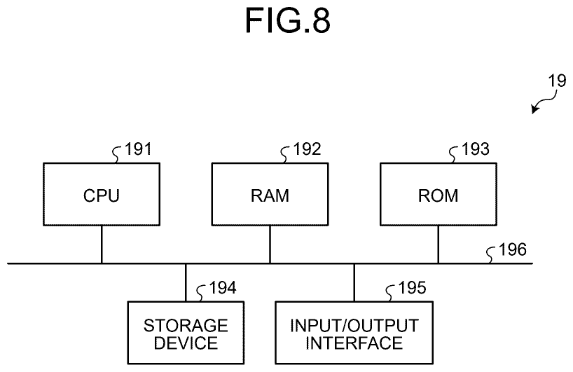

FIG. 8 is a block diagram illustrating an example of a hardware configuration of the control device included in the additive manufacturing apparatus according to the first embodiment. The control device 19 includes a central processing unit (CPU) 191 that executes various types of processing, random access memory (RAM) 192 including a data storage area, read-only memory (ROM) 193 that is nonvolatile memory, a storage device 194, and an input/output interface 195 for inputting information to the control device 19 and outputting information from the control device 19. The parts illustrated in FIG. 8 are connected to each other via a bus 196.

The CPU 191 executes a program stored in the ROM 193 or the storage device 194. The overall control of the additive manufacturing apparatus 1 performed by the control device 19 is implemented using the CPU 191.

The storage device 194 is a hard disk drive (HDD) or a solid-state drive (SSD). The storage device 194 stores the control program and various data. The ROM 193 stores software or a program to control hardware which is a boot loader such as the Basic Input/Output System (BIOS) or the Unified Extensible Firmware Interface (UEFI), which is a program for basic control of a computer or a controller that is the control device 19. The control program may be stored in the ROM 193.

The programs stored in the ROM 193 and the storage device 194 are loaded into the RAM 192. The CPU 191 develops the control program in the RAM 192 and executes the various types of processing. The input/output interface 195 is an interface for connection with an apparatus outside the control device 19. The processing program is input to the input/output interface 195. The input/output interface 195 outputs the various commands. The control device 19 may include input devices such as a keyboard and a pointing device, and an output device such as a display.

The control program may be stored in a computer-readable storage medium. The control device 19 may store the control program stored in the storage medium in the storage device 194. The storage medium may be a portable storage medium that is a flexible disk, or flash memory that is semiconductor memory. The control program may be installed on a computer or a controller to be the control device 19 from another computer or a server device via a communication network.

The functions of the control device 19 may be implemented by processing circuitry that is dedicated hardware for controlling the additive manufacturing apparatus 1. The processing circuitry is a single circuit, a combined circuit, a programmed processor, a parallel-programmed processor, an application-specific integrated circuit (ASIC), a field-programmable gate array (FPGA), or a combination thereof. Part of the functions of the control device 19 may be implemented by dedicated hardware, and the other part may be implemented by software or firmware.

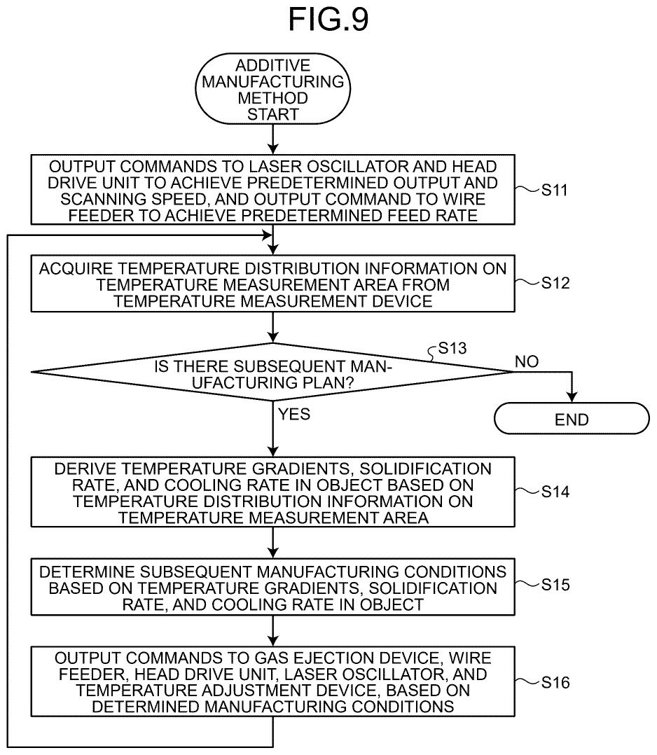

Next, an additive manufacturing method in the additive manufacturing apparatus 1 according to the first embodiment will be described. By the additive manufacturing method, a three-dimensional additively manufactured object is manufactured. Thus, the additive manufacturing method described below is also a method of manufacturing an additively manufactured object. FIG. 9 is a flowchart illustrating an example of a processing procedure of the additive manufacturing method according to the first embodiment. FIG. 9 illustrates a processing procedure of the control device 19 in the additive manufacturing apparatus 1.

First, the control device 19 outputs commands to the laser oscillator 16 and the head drive unit 15 so as to achieve a predetermined output and scanning speed of the laser beam L, and outputs a command to the wire feeder 14 so as to achieve a predetermined feed rate (step S11). Consequently, the wire feeder 14 feeds the wire W onto the workpiece at the predetermined feed rate of the wire W, and the beam irradiation device 12 and the head drive unit 15 emits the laser beam L onto the workpiece at the predetermined output and scanning speed. As a result, a manufacturing process is performed in which a layer formed by the wire W melted and solidified is added onto the workpiece.

During the manufacturing process, the temperature measurement device 17 measures temperature distribution in a temperature measurement area that is an area including the entire area in which to form the object 112. That is, the temperature measurement device 17 measures temperature distribution in the entire object 112 from the initial layer 113 to the final layer 114 including the melt pool 115 being formed, at the time of formation of each layer. The control device 19 acquires temperature distribution information that is the results of the measurement of the temperature distribution in the temperature measurement area from the temperature measurement device 17 (step S12).

Next, the control device 19 determines whether there is a subsequent manufacturing plan (step S13). A manufacturing plan is information on the manufacturing of the additively manufactured object, and is, in one example, information including the height of the object 112. The subsequent manufacturing plan is a plan for forming a layer following the currently formed layer in the manufacturing plan. In one example, if the height of the object 112 formed so far is less than the height in the manufacturing plan, there is a subsequent manufacturing plan. If the height of the object 112 formed so far is equal to the height in the manufacturing plan, there is no subsequent manufacturing plan. In one example, by analyzing the processing program to perform the manufacturing process, the control device 19 can determine the presence or absence of a subsequent manufacturing plan according to whether the manufacturing process on the layer currently being formed is continued or the manufacturing process is completed.

When the control device 19 determines that there is no subsequent manufacturing plan (No in step S13), that is, determines that the manufacturing process is completed in the currently formed layer, the control device 19 ends the additive manufacturing process.

When the control device 19 determines that there is a subsequent manufacturing plan (Yes in step S13), the control device 19 derives temperature gradients, a solidification rate, and a cooling rate in the object 112, based on the temperature distribution information on the temperature measurement area acquired in step S12 (step S14). In one example, the control device 19 identifies the solid-liquid interface 116 using the temperature distribution information and the melting point of the material, and derives temperature gradients at the solid-liquid interface 116. The control device 19 derives temperature gradients in a direction perpendicular to the layer stacking direction and in the height direction, which is the stacking direction. The control device 19 derives a solidification rate at the solid-liquid interface 116, using the temperature distribution information at a plurality of time points. The control device 19 derives a cooling rate at an arbitrary position, using a plurality of pieces of the temperature distribution information at different time points. Note that the temperature gradients, the solidification rate, and the cooling rate may vary from layer to layer even at the same position in the temperature measurement area. In one example, the formation of an initial layer causes small heat storage in the workpiece, but repeated formation increases heat storage in the workpiece. Therefore, the temperature gradients, the solidification rate, and the cooling rate are affected by the base.

Next, the control device 19 determines subsequent manufacturing conditions, based on the temperature gradients, the solidification rate, and the cooling rate in the object 112 derived in step S14 (step S15). Specifically, the control device 19 determines the manufacturing conditions for the gas ejection device 13, the wire feeder 14, the head drive unit 15, the laser oscillator 16, and the temperature adjustment device 18 at the time of forming the next layer, with reference to the manufacturing condition information, so that the derived temperature gradient, solidification rate, and cooling rate in the object 112 fall within the predetermined thresholds.

Then, based on the determined manufacturing conditions, the control device 19 outputs commands to the gas ejection device 13, the wire feeder 14, the head drive unit 15, the laser oscillator 16, and the temperature adjustment device 18 (step S16). Thus, the control device 19 controls subsequent manufacturing conditions in the additive manufacturing apparatus 1, in one example, manufacturing conditions for a layer to be formed next. This control allows the entire workpiece to be formed under manufacturing conditions under which the temperature gradients, the solidification rate, and the cooling rate become close to desired thresholds, and the entire structure of the workpiece to be homogenized. After that, the process returns to step S12. Then, the above process is repeatedly performed until there is no subsequent manufacturing plan.

According to the first embodiment, the temperature measurement device 17 measures temperature distribution in an entire temperature measurement area that is a forming area on the substrate 111. The control device 19 derives temperature gradients, a solidification rate, and a cooling rate at each position in the object 112 from temperature distribution information indicating the temperature distribution in the temperature measurement area. The control device 19 determines manufacturing conditions from manufacturing condition information so that temperature gradients, a solidification rate, and a cooling rate in a layer to be formed subsequently fall within desired thresholds. Thus, control is performed such that the temperature gradients, the solidification rate, and the cooling rate in the object 112 in the temperature measurement area fall within the desired thresholds in each layer from a manufacturing initial stage to final stage. As a result, the structure of each layer becomes uniform, and the entire object 112 can be homogenized into a desired structure. Furthermore, the temperature measurement area widely covers down to the initial layer 113, so that the entire object 112 can be homogenized into a desired structure with consideration given to thermal influence on a subsequent path and heat storage during formation. In addition, using a two-color thermography camera as the temperature measurement device 17 allows the acquisition of accurate temperature distribution information on the entire object 112 whose emissivity successively changes.

Note that the temperature measurement device 17 measures the temperature of the surface of the object 112, and does not measure the temperature of the interior of the object 112. The material fed by the additive manufacturing apparatus 1 is metal, and metal is generally a material having a high thermal conductivity. As a result of thermal analysis of temperature distribution during formation, it is confirmed that a temperature history at a point inside the object 112 formed of a material having a high thermal conductivity is substantially the same as that at a point on the surface of the object 112. That is, the temperature of the surface of the object 112 can substitute for the temperature of the interior of the object 112. Therefore, as described above, the temperature of the surface of the object 112 is measured by the use of the temperature measurement device 17, and, based on the measured temperature of the surface, the entire structure including the interior of the object 112 can be homogenized.

### Second Embodiment

A second embodiment describes a method of controlling the structure of the object 112 by estimating the crystal shape of the structure based on derived temperature gradients and a derived solidification rate and performing heating and cooling treatment after formation. The additive manufacturing apparatus 1 used in the second embodiment is the same as that described in the first embodiment, and thus the description thereof will be omitted. However, the functions of the control device 19 in the additive manufacturing apparatus 1 used in the second embodiment are different from those in the first embodiment.

The control device 19 derives temperature gradients and a solidification rate from temperature distribution information on the object 112, and estimates the crystal shape of the structure of the object 112 at the derived temperature gradients and solidification rate from structural crystal shape information indicating the relationship between the temperature gradient and the solidification rate and the crystal shape of the structure. The structural crystal shape information is obtained in advance. The control device 19 determines whether the estimated crystal shape of the structure is the crystal shape of a desired structure. When the estimated crystal shape of the structure is different from the crystal shape of the desired structure, the control device 19 suspends a manufacturing process and determines heating and cooling conditions for the object 112, based on the estimation result. Specifically, the control device 19 determines heating and cooling conditions under which the object 112 achieves the crystal shape of the desired structure from a temperature gradient and a solidification rate associated with the crystal shape of the desired structure, and from the derived temperature gradients and solidification rate. Then, the control device 19 controls the gas ejection device 13, the head drive unit 15, the laser oscillator 16, and the temperature adjustment device 18, based on the determined heating and cooling conditions. That is, the control device 19 does not feed the wire W but performs heat treatment by controlling the emission of the laser beam L and the ejection of the shielding gas G to the object 112 and controlling the temperature of the substrate 111 under the determined heating and cooling conditions. After the heat treatment, the control device 19 performs the manufacturing process by controlling the gas ejection device 13, the wire feeder 14, the head drive unit 15, the laser oscillator 16, and the temperature adjustment device 18, based on determined manufacturing conditions. When the estimated crystal shape of the structure is the crystal shape of the desired structure, the control device 19 performs the manufacturing process by controlling the gas ejection device 13, the wire feeder 14, the head drive unit 15, the laser oscillator 16, and the temperature adjustment device 18, based on the determined manufacturing conditions, without suspending the manufacturing process that is, without performing treatment under the heating and cooling conditions.

In the present description, the heating and cooling conditions refer to heat treatment conditions after the final layer 114 is formed, for controlling the structure of the object 112 by reheating or recooling the solidified object 112 in a temperature range lower than or equal to the melting point of the wire W. In one example, the heat treatment conditions after formation are conditions for controlling the laser beam L, the shielding gas G, and the operation of the temperature adjustment device 18 to reheat or recool the solidified object 112.

The relationship between the temperature gradient and the solidification rate and the crystal shape of the structure is not particularly limited, and can be obtained by any method in advance. In one example, a temperature gradient and a solidification rate under arbitrary manufacturing conditions may be acquired in advance by thermal analysis using the finite element method, and the structural shape of the object 112 under the same manufacturing conditions may be identified by structural observation in advance. That is, information in which manufacturing conditions, temperature gradients and solidification rates, and the crystal shapes of the structure as the results of structural observation are associated with each other may be stored as the structure crystal state information in advance. Alternatively, the relationship between the temperature gradient and the solidification rate and the crystal shape of the structure may be obtained from a known database published in a literature or the like.

The relationship between the heating and cooling conditions and the temperature gradient and the solidification rate is not particularly limited, and can be obtained by any method in advance. In one example, a temperature gradient and a solidification rate under arbitrary heating and cooling conditions may be acquired in advance by thermal analysis using the finite element method. That is, information in which heating and cooling conditions are associated with temperature gradients and solidification rates may be stored in advance. Alternatively, the relationship between the heating and cooling conditions and the temperature gradient and the solidification rate may be obtained from experimental values using the actual object 112.

In one example, when the shape of the desired structure of the object 112 is an equiaxed structure, and the estimated crystal shape of the structure is a columnar structure, the control device 19 suspends the manufacturing process and determines the heating and cooling conditions under which the structure of the object 112 becomes the equiaxed structure, based on the structural crystal shape information indicating the relationship between the temperature gradient and the solidification rate and the crystal shape of the structure. In one example, the combination of a temperature gradient and a solidification rate for achieving the desired structure is obtained, and the heating and cooling conditions for the object 112 are determined so that the structure indicated by the combination of the temperature gradient and the solidification rate derived from the temperature distribution information becomes the obtained combination of the temperature gradient and the solidification rate. That is, the operating conditions for the gas ejection device 13, the head drive unit 15, the laser oscillator 16, and the temperature adjustment device 18 are determined. At this time, the combination of the temperature gradient and the solidification rate associated with the crystal shape of the desired structure is obtained from the structural crystal shape information, and the heating and cooling conditions associated with the crystal shape of the desired structure are determined based on the combination of the temperature gradient and the solidification rate associated with the crystal shape of the desired structure, and the combination of the temperature gradient and the solidification rate derived from the temperature distribution information on the object 112. After that, the control device 19 outputs commands to the gas ejection device 13, the head drive unit 15, the laser oscillator 16, and the temperature adjustment device 18, based on the determined heating and cooling conditions. Consequently, control on heating treatment or cooling treatment for the shape of the structure of the object 112 to become the equiaxed structure, that is, control on heat treatment is performed. That is, a treatment to achieve the desired structure by applying heating treatment or cooling treatment to the object 112 including the formed final layer 114 is performed while the manufacturing process is suspended. After that, the manufacturing process is resumed. That is, the manufacturing process on the next layer is performed based on the manufacturing conditions.

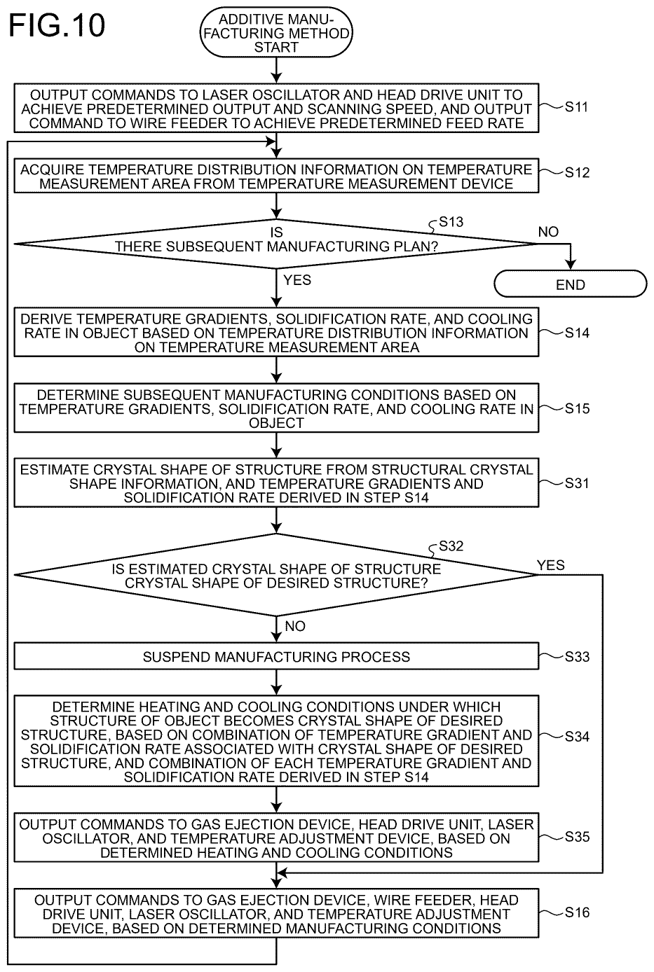

FIG. 10 is a flowchart illustrating an example of a processing procedure of an additive manufacturing method according to the second embodiment. FIG. 10 illustrates a processing procedure of the control device 19 in the additive manufacturing apparatus 1. The same pieces of processing as those in FIG. 9 are denoted by the same step numbers, and the description thereof will be omitted.

After step S15, the control device 19 estimates the crystal shape of the structure from previously obtained structural crystal shape information indicating the relationship between the temperature gradient and the solidification rate and the crystal shape of the structure, and from the temperature gradients and the solidification rate derived in step S14 (step S31).

After that, the control device 19 determines whether the estimated crystal shape of the structure is the crystal shape of a desired structure (step S32). When the control device 19 determines that the estimated crystal shape of the structure is the crystal shape of the desired structure (Yes in step S32), the process proceeds to step S16. That is, in this case, since the crystal shape of the structure of the formed object 112 has the crystal shape of the desired structure, heating treatment or cooling treatment for changing the crystal shape of the structure is unnecessary for the object 112. Therefore, the subsequent manufacturing plan described in the first embodiment is performed based on the determined manufacturing conditions.

On the other hand, when the control device 19 determines that the estimated crystal shape of the structure is different from the crystal shape of the desired structure (No in step S32), the control device 19 suspends the manufacturing process (step S33).

Next, the control device 19 determines heating and cooling conditions under which the structure of the object 112 becomes the crystal shape of the desired structure, based on the combination of a temperature gradient and a solidification rate associated with the crystal shape of the desired structure, and the combination of the temperature gradient and the solidification rate derived in step S14 (step S34). After that, the control device 19 outputs commands to the gas ejection device 13, the head drive unit 15, the laser oscillator 16, and the temperature adjustment device 18, based on the determined heating and cooling conditions (step S35). By thus performing control of the emission of the laser beam L and the ejection of the shielding gas G to the object 112 and control of the temperature of the substrate 111 without feeding the wire W, heat treatment after the formation of the object 112 is performed for controlling the structure of the object 112. After that, the process returns to step S16, and the manufacturing process is resumed.

According to the second embodiment, the control device 19 estimates the crystal shape of the structure of the object 112 from temperature gradients and a solidification rate. When the estimated crystal shape of the structure is the crystal shape of a desired structure, the manufacturing process is continued. On the other hand, when the estimated crystal shape of the structure is not the crystal shape of the desired structure, the control device 19 temporarily suspends the manufacturing process, and controls the additive manufacturing apparatus 1 under heating and cooling conditions determined so that the crystal shape of the structure becomes the crystal shape of the desired structure, to perform heat treatment on the object 112. Consequently, even when the formed object 112 does not have the crystal shape of the desired structure, the treatment based on the heating and cooling conditions can be performed to achieve the crystal shape of the desired structure. As a result, the entire object 112 can be homogenized into the desired structure.

### Third Embodiment

A third embodiment describes a method of controlling the structure of the object 112 by estimating the size of the structure and the type of precipitated phase, based on a derived cooling rate, and performing a heating and cooling treatment after formation. The additive manufacturing apparatus 1 used in the third embodiment is the same as that described in the first embodiment, and thus the description thereof will be omitted. However, the functions of the control device 19 in the additive manufacturing apparatus 1 used in the third embodiment are different from those in the first embodiment.

The control device 19 derives a cooling rate from temperature distribution information on the object 112, and estimates the structure size and precipitated phase type of the object 112 at the derived cooling rate from structure and precipitated phase information that indicates the relationship between the cooling rate and the structure size and precipitated phase type of the object 112. The structure and precipitated phase information is obtained in advance. The control device 19 determines whether the estimated structure size and precipitated phase type are a desired structure size and precipitated phase type. When the estimated structure size and precipitated phase type are different from the desired structure size and precipitated phase type, the control device 19 suspends a manufacturing process and determines heating and cooling conditions for the object 112, based on the estimation results. Specifically, the control device 19 determines heating and cooling conditions under which the object 112 achieves the desired structure size and precipitated phase type, from a cooling rate associated with the desired structure size and precipitated phase type and the derived cooling rate. Then, the control device 19 controls the gas ejection device 13, the head drive unit 15, the laser oscillator 16, and the temperature adjustment device 18, based on the heating and cooling conditions. That is, the control device 19 does not feed the wire W and performs heat treatment by controlling the emission of the laser beam L and the ejection of the shielding gas G to the object 112 and controlling the temperature of the substrate 111 under the determined heating and cooling conditions. After the heat treatment, the control device 19 performs the manufacturing process by controlling the gas ejection device 13, the wire feeder 14, the head drive unit 15, the laser oscillator 16, and the temperature adjustment device 18, based on determined manufacturing conditions. When the estimated structure size and precipitated phase type are the desired structure size and precipitated phase type, the control device 19 performs the manufacturing process under the determined manufacturing conditions without suspending the manufacturing process, that is, without performing treatment under the heating and cooling conditions. That is, based on the manufacturing conditions, the control device 19 controls the gas ejection device 13, the wire feeder 14, the head drive unit 15, the laser oscillator 16, and the temperature adjustment device 18, to perform the manufacturing process.

The relationship between the cooling rate and the structure size and the precipitated phase type is not particularly limited, and can be obtained by any method in advance. In one example, a cooling rate under arbitrary manufacturing conditions may be acquired in advance by thermal analysis using the finite element method, and the structure size and the precipitated phase type of the object 112 under the same manufacturing conditions may be identified by structural observation in advance. That is, information in which manufacturing conditions, cooling rates, and structure sizes and precipitated phase types that are the results of structural observation are associated with each other may be stored as the structure and precipitated phase information in advance. Alternatively, the relationship between the cooling rate and the structure size and the precipitated phase type may be obtained from a known database published in a literature or the like. In one example, when the estimated structure size and precipitated phase type are different from the desired structure size and precipitated phase type, a cooling rate associated with the desired structure size and precipitated phase is obtained from the structure and precipitated phase information, and heating and cooling conditions associated with the desired structure size and precipitated phase type are determined based on the cooling rate associated with the desired structure size and precipitated phase type, and based on the cooling rate derived from the temperature distribution information on the object 112.

The relationship between the heating and cooling conditions and the cooling rate is not particularly limited, and can be obtained by any method in advance. In one example, a cooling rate under arbitrary heating and cooling conditions may be acquired in advance by thermal analysis using the finite element method. That is, information in which heating and cooling conditions are associated with cooling rates may be stored in advance. Alternatively, the relationship between the heating and cooling conditions and the cooling rate may be obtained from experimental values using the actual object 112.

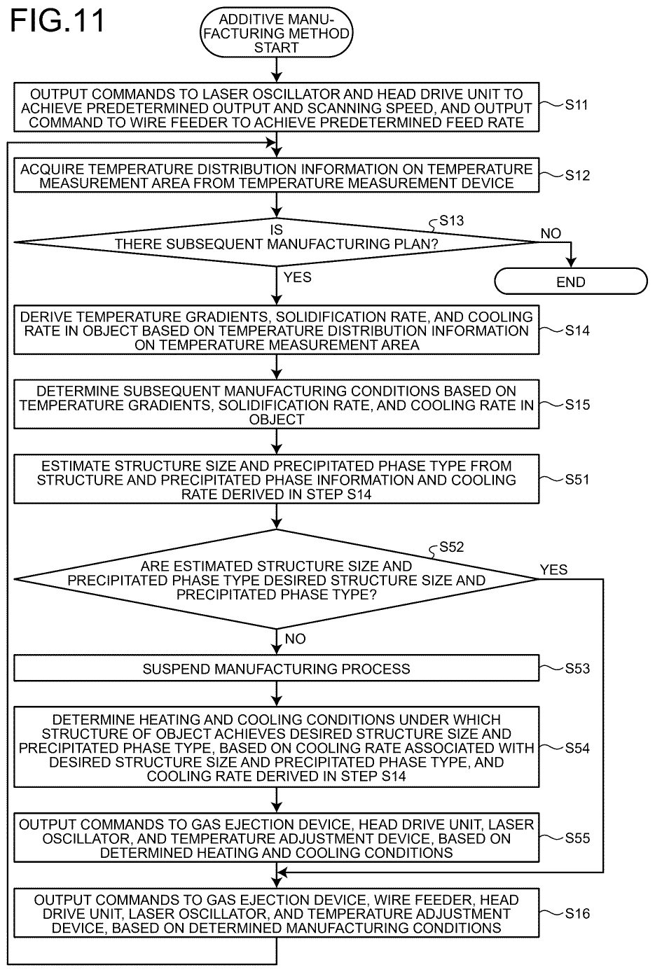

FIG. 11 is a flowchart illustrating an example of a processing procedure of an additive manufacturing method according to the third embodiment. FIG. 11 illustrates a processing procedure of the control device 19 in the additive manufacturing apparatus 1. The same pieces of processing as those in FIG. 9 are denoted by the same step numbers, and the description thereof will be omitted.

After step S15, the control device 19 estimates the structure size and the precipitated phase type from previously obtained structure and precipitated phase information indicating the relationship between the cooling rate and the structure size and the precipitated phase type, and from the cooling rate derived in step S14 (step S51).

After that, the control device 19 determines whether the estimated structure size and precipitated phase type are a desired structure size and precipitated phase type (step S52). When the control device 19 determines that the estimated structure size and precipitated phase type are the desired structure size and precipitated phase type (Yes in step S52), the process proceeds to step S16. That is, in this case, since the structure size and precipitated phase type of the formed object 112 have the desired structure size and precipitated phase type, heating treatment of cooling treatment for changing the structure size and the precipitated phase type is unnecessary for the object 112. Therefore, the subsequent manufacturing plan described in the first embodiment is performed based on the determined manufacturing conditions.

On the other hand, when the control device 19 determines that the estimated structure size and precipitated phase type are different from the desired structure size and precipitated phase type (No in step S52), the control device 19 suspends the manufacturing process (step S53).

Next, the control device 19 determines heating and cooling conditions under which the structure of the object 112 achieves the desired structure size and precipitated phase type, based on a cooling rate associated with the desired structure size and precipitated phase type, and the cooling rate derived in step S14 (step 854). After that, the control device 19 outputs commands to the gas ejection device 13, the head drive unit 15, the laser oscillator 16, and the temperature adjustment device 18, based on the determined heating and cooling conditions (step S55). By thus performing control of the emission of the laser beam L and the ejection of the shielding gas G to the object 112 and control of the temperature of the substrate 111 without feeding the wire W, heat treatment after formation is performed for controlling the structure of the object 112. After that, the process returns to step S16, and the manufacturing process is resumed.

According to the third embodiment, the control device 19 estimates the structure size and the precipitated phase type of the object 112 from a cooling rate. When the estimated structure size and precipitated phase type are a desired structure size and precipitated phase type, the manufacturing process is continued. On the other hand, when the estimated structure size and precipitated phase type are different from the desired structure size and precipitated phase type, the control device 19 temporarily suspends the manufacturing process, and controls the additive manufacturing apparatus 1 under heating and cooling conditions determined so that the structure size and the precipitated phase type become the same as the desired structure size and precipitated phase type, to perform heat treatment on the object 112. Consequently, even when the formed object 112 does not have the desired structure size and precipitated phase type, the treatment based on the heating and cooling conditions can be performed to achieve the desired structure size and precipitated phase type. As a result, the entire object 112 can be homogenized into the desired structure.

The configurations described in the above embodiments illustrate an example, and can be combined with another known art. The embodiments can be combined with each other. The configurations can be partly omitted or changed without departing from the gist.

### REFERENCE SIGNS LIST

1 additive manufacturing apparatus; 11 stage; 12 beam irradiation device; 13 gas ejection device; 14 wire feeder; 15 head drive unit; 16 laser oscillator; 17 temperature measurement device; 18 temperature adjustment device; 19 control device; 111 substrate; 112 object; 113 initial layer; 114 final layer; 114a, 114b layer; 115 melt pool; 116 solid-liquid interface; G shielding gas; laser beam; W wire.

1. An additive manufacturing apparatus to form an object by stacking a layer that is a layer of a molten metal on a substrate serving as a base on which to form the object, the apparatus comprising:
a material feed device to feed a material in a form of wire or powder to a workpiece that is a layer-forming target, on which area to form a layer;
a heat source supply device to supply a heat source to melt the material to the workpiece;
a temperature measurement device disposed so as to be able to measure temperature of a top surface and temperature of a side surface of the object in a temperature measurement area that is an area including an entire area in which to form the object;
a temperature adjustment device to perform temperature adjustment by heating or cooling the object; and
control circuitry to control the material feed device, the heat source supply device, and the temperature adjustment device, wherein
the control circuitry derives a temperature gradient in a direction perpendicular to a stacking direction of the layer at each position in a final layer that is an uppermost layer being formed in the object, and a temperature gradient in the stacking direction at each position on a side surface of the object, using temperature distribution information that is results of measurement of the temperature of the temperature measurement area by the temperature measurement device, and derives a solidification rate and a cooling rate at each position in the object, based on the temperature distribution information at different times,
the control circuitry determines manufacturing conditions for forming a layer to be subsequently formed so that the derived temperature gradient, solidification rate, and cooling rate become a temperature gradient, a solidification rate, and a cooling rate for forming a desired structure, and
the control circuitry controls the material feed device, the heat source supply device, and the temperature adjustment device, based on the manufacturing conditions, to perform a manufacturing process.

2. The additive manufacturing apparatus according to claim 1, wherein the temperature measurement device is a two-color thermography camera to measure the temperature of the temperature measurement area from an intensity ratio of two different wavelengths.

3. The additive manufacturing apparatus according to claim 1, wherein
the temperature adjustment device includes a first temperature adjustment device to heat or cool the substrate,
the temperature measurement device sets, as the temperature measurement area, an area including the substrate in addition to the entire area in which to form the object, and
the control circuitry controls the material feed device, the heat source supply device, and the temperature adjustment device, based on the manufacturing conditions.

4. The additive manufacturing apparatus according to claim 1, wherein
the temperature adjustment device includes a second temperature adjustment device to eject an inert gas to the workpiece to cool the workpiece,
the temperature measurement device sets, as the temperature measurement area, an area including the substrate in addition to the entire area in which to form the object, and
the control circuitry controls the material feed device, the heat source supply device, and the temperature adjustment device, based on the manufacturing conditions.

5. The additive manufacturing apparatus according to claim 3, wherein
the control circuitry estimates a crystal shape of a structure of the object at the derived temperature gradient and solidification rate from structural crystal shape information indicating a relationship between the temperature gradient and the solidification rate and the crystal shape of the structure, and
the control circuitry determines whether the estimated crystal shape of the structure is a crystal shape of a desired structure.

6. The additive manufacturing apparatus according to claim 5, wherein the control circuitry controls the material feed device, the heat source supply device, and the temperature adjustment device, based on the manufacturing conditions, when the estimated crystal shape of the structure is the crystal shape of the desired structure.

7. The additive manufacturing apparatus according to claim 5, wherein
when the estimated crystal shape of the structure is not the crystal shape of the desired structure,
the control circuitry suspends the manufacturing process,
the control circuitry determines heating and cooling conditions under which the object achieves the crystal shape of the desired structure, based on a combination of a temperature gradient and a solidification rate associated with the crystal shape of the desired structure, and a combination of the derived temperature gradient and the derived solidification rate,
the control circuitry controls the heat source supply device and the temperature adjustment device, based on the heating and cooling conditions, to perform heat treatment, and
the control circuitry controls the material feed device, the heat source supply device, and the temperature adjustment device, based on the manufacturing conditions, after the heat treatment.

8. The additive manufacturing apparatus according to claim 3, wherein
the control circuitry estimates a structure size and a precipitated phase type of the object at the derived cooling rate from structure and precipitated phase information that indicates a relationship between the cooling rate and the structure size and the precipitated phase type, and
the control circuitry determines whether the estimated structure size and precipitated phase type are a desired structure size and precipitated phase type.

9. The additive manufacturing apparatus according to claim 8, wherein the control circuitry controls the material feed device, the heat source supply device, and the temperature adjustment device, based on the manufacturing conditions, when the estimated structure size and precipitated phase type are the desired structure size and precipitated phase type.

10. The additive manufacturing apparatus according to claim 8, wherein
when the estimated structure size and precipitated phase type are not the desired structure size and precipitated phase type,
the control circuitry suspends the manufacturing process,
the control circuitry determines heating and cooling conditions under which the object achieves the desired structure size and precipitated phase type, based on a cooling rate associated with the desired structure size and precipitated phase type, and the derived cooling rate,
the control circuitry controls the heat source supply device and the temperature adjustment device, based on the heating and cooling conditions, to perform heat treatment, and
the control circuitry controls the material feed device, the heat source supply device, and the temperature adjustment device, based on the manufacturing conditions, after the heat treatment.

11. The additive manufacturing apparatus according to claim 4, wherein
the control circuitry estimates a crystal shape of a structure of the object at the derived temperature gradient and solidification rate from structural crystal shape information indicating a relationship between the temperature gradient and the solidification rate and the crystal shape of the structure, and
the control circuitry determines whether the estimated crystal shape of the structure is a crystal shape of a desired structure.

12. The additive manufacturing apparatus according to claim 11, wherein the control circuitry controls the material feed device, the heat source supply device, and the temperature adjustment device, based on the manufacturing conditions, when the estimated crystal shape of the structure is the crystal shape of the desired structure.

13. The additive manufacturing apparatus according to claim 11, wherein
when the estimated crystal shape of the structure is not the crystal shape of the desired structure,
the control circuitry suspends the manufacturing process,
the control circuitry determines heating and cooling conditions under which the object achieves the crystal shape of the desired structure, based on a combination of a temperature gradient and a solidification rate associated with the crystal shape of the desired structure, and a combination of the derived temperature gradient and the derived solidification rate,
the control circuitry controls the heat source supply device and the temperature adjustment device, based on the heating and cooling conditions, to perform heat treatment, and
the control circuitry controls the material feed device, the heat source supply device, and the temperature adjustment device, based on the manufacturing conditions, after the heat treatment.

14. The additive manufacturing apparatus according to claim 4, wherein
the control circuitry estimates a structure size and a precipitated phase type of the object at the derived cooling rate from structure and precipitated phase information that indicates a relationship between the cooling rate and the structure size and the precipitated phase type, and
the control circuitry determines whether the estimated structure size and precipitated phase type are a desired structure size and precipitated phase type.

15. The additive manufacturing apparatus according to claim 14, wherein the control circuitry controls the material feed device, the heat source supply device, and the temperature adjustment device, based on the manufacturing conditions, when the estimated structure size and precipitated phase type are the desired structure size and precipitated phase type.

16. The additive manufacturing apparatus according to claim 14, wherein
when the estimated structure size and precipitated phase type are not the desired structure size and precipitated phase type,
the control circuitry suspends the manufacturing process,
the control circuitry determines heating and cooling conditions under which the object achieves the desired structure size and precipitated phase type, based on a cooling rate associated with the desired structure size and precipitated phase type, and the derived cooling rate,
the control circuitry controls the heat source supply device and the temperature adjustment device, based on the heating and cooling conditions, to perform heat treatment, and
the control circuitry controls the material feed device, the heat source supply device, and the temperature adjustment device, based on the manufacturing conditions, after the heat treatment.
